(19) United States
(12) Patent Application Publication
(10) Pub. No.: US 2014/0098530 A1
(43) Pub. Date: Apr. 10, 2014

(54) DIRECTIONALLY CONTROLLABLE STREET LAMP

(71) Applicant: Itai Leshniak, Fair Lawn, NJ (US)

(72) Inventor: Itai Leshniak, Fair Lawn, NJ (US)

(73) Assignee: Amerlux, LLC, Fairfield, NJ (US)

(21) Appl. No.: 13/975,137

(22) Filed: Aug. 23, 2013

Related U.S. Application Data
(63) Continuation of application No. PCT/US2012/033572, filed on Apr. 13, 2012.
(60) Provisional application No. 61/475,111, filed on Apr. 13, 2011.

(51) Int. Cl. H05B 33/08; F21V 3/00; F21V 5/00

(52) U.S. Cl. CPC H05B 33/0806; F21V 5/00; F21V 3/00
USPC 362/235; 362/249.01; 362/249.02

(57) ABSTRACT

A street lamp 10 is disclosed, in which a head 12 thereof includes a plurality of luminaires 14-20, which are circumferentially offset relative to a top view thereof, whereby the plurality of luminaires 14-20 face a corresponding plurality of directions. One or more controllers 26 are provided for individually controlling the luminosity of the plurality of luminaires 14-20, whereby various, controllable light patterns are provided about a circumference of the lamp, with or without utilizing a refracting lamp cover.

### CONTINUITY

This application is a U.S. National Stage of International Application No. PCT/US2012/033572, filed Apr. 13, 2012, which claims priority to U.S. Provisional Patent Application No. 61/475,111 for a Variable Directivity Luminaire, filed Apr. 13, 2011. The entire contents of each of the above referenced applications are incorporated herein by reference in their entirety for any purpose whatsoever.

### BACKGROUND

1. Field of the Disclosure

The disclosure relates to a street lamp having plural independently controllable luminaires in one head which enable selectively throwing and concentrating light in different directions.

2. Background of the Disclosure

In a traditional luminaire configuration, the lamp creates light at a given point, usually with a three hundred and sixty degree distribution in the horizontal plane. That is, light projects radially outwardly from a point source in the head and is distributed evenly about the full circumference of the head so that each of the recognized eight horizontal octants would be uniformly lit. Refractors can be provided so that fixed patterns, defined by the Illuminating Engineering Society of North America (IESNA) are obtained.

There are circumstances where fixed patterns are not desirable. For example, during evening business hours, light need not be thrown at a street side restaurant, while such lighting may be appropriate after close of business for the establishment. Known street lights are ill equipped to continuously throw light towards a street during all evening hours while throwing light towards a restaurant or other street-side establishment during certain hours.

### SUMMARY OF THE DISCLOSURE

A street lamp 10 is disclosed, in which a head 12 thereof includes a plurality of luminaires 14-20, which are circumferentially offset relative to a top view thereof, whereby the plurality of luminaires 14-20 face a corresponding plurality of directions. One or more controllers 26 are provided for individually controlling the luminosity of the plurality of luminaires 14-20, whereby various, controllable light patterns are provided about a circumference of the lamp, with or without utilizing a refracting lamp cover.

### BRIEF DESCRIPTION OF THE FIGURES

The disclosed embodiments are illustrated in the accompanying figures, in which:

FIG. 1 illustrates a street lamp positioned between a street and a building;

FIG. 2 illustrates a head of the street lamp;

FIG. 3 illustrates the positioning of plural LED boards with the head;

FIG. 4 illustrates a controller for controlling the plural LEDs;

FIG. 5 illustrates a controller with plural drivers for controlling the plural LEDs; and

FIG. 6 illustrates a controller with a multichannel driver for controlling the plural LEDs.

### DETAILED DESCRIPTION OF THE DISCLOSED EMBODIMENTS

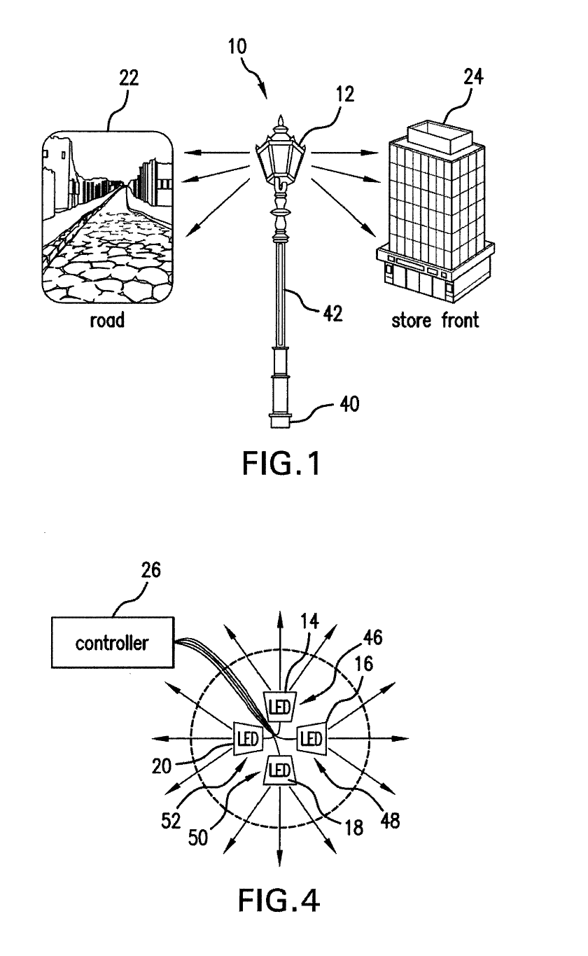

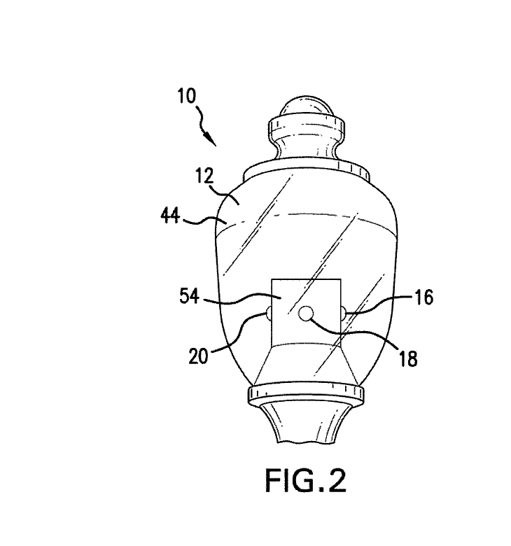

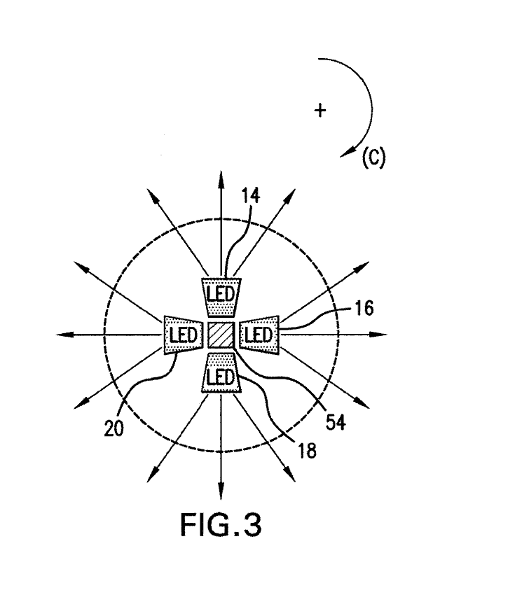

A street lamp 10 is illustrated in FIG. 1, which includes a head 12 (FIG. 2) at a top thereof. The head 45 includes a plurality of luminaires 14-20 (FIG. 3), which are circumferentially (that is, in cylindrical coordinates) offset relative to a top view thereof. From this configuration, the plurality of luminaires 14-20 faces a corresponding plurality of directions. In FIG. 1, the directions include street roadways on one side thereof and buildings 24 on the other side thereof.

The configuration includes one or more controllers 26 (see FIG. 4) for individually controlling the luminosity of the plurality of luminaires 14-20. From this configuration, various, controllable light patterns are provided about a circumference of the lamp, with or without utilizing a refracting lamp cover.

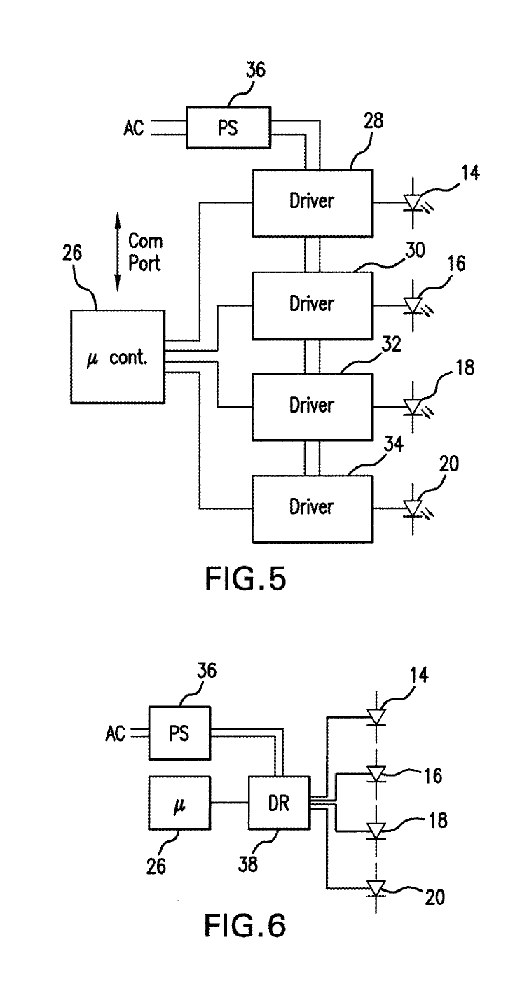

The controller, as illustrated in FIG. 5, can be one manufactured by Magtechind, which can be found at www.Magtechind.com. The controller can be for example, part number cc-2512, which is an LED dimmer and controller. This in combination with a microprocessor can control different light perceived luminosity for each luminaire, as discussed below.

The plurality of luminaires 14-20 include at least two luminaires (FIG. 2; e.g., 16, 20) spaced in radially opposing directions relative to a top view of the street lamp. The luminaires face, e.g., into the street and at buildings.

As illustrated, the plurality of luminaires 14-20 includes at least four luminaires (e.g., each of luminaires 14-20). The illustrated luminaires are spaced circumferentially equally relative to a top view of the street lamp. There is no upside limit to the number of luminaires which may be circumferentially offset and even axially offset while circumferentially aligned within the head. A finer control and greater light output will be provided by utilizing more programmable light sources within the head.

The plural luminaires 14-20 are plural LED boards and the lamp configuration includes one or more LED drivers. An LED driver is a self-contained power supply that has outputs matched to the electrical characteristics of an LED or array of LEDs. Drivers may also offer dimming by means of pulse width modulation (PWM) circuits, or via current reduction.

For example, (FIG. 5) plural drivers are provided 28-34, one for each respective LED board. The drivers can be HV9910 drivers by Supertex Inc, obtainable at Supertex.com. On the input side, the drivers are connected to a microprocessor 26, which facilitates the output of, for example, current reduction dimming or a Pulse Width Modulated (PWM) signal providing dimming protocols. From this, the light can appear either dimmer or brighter. The drivers may be powered by a power source 36 which can be 110 VAC, 240 VAC, 277 VAC, as examples, depending on the local power supply in the different countries.

As compared with plural drivers, a single multichannel driver 38 can be provided, wherein each channel is separately controllable by the controller for individually powering each LED board.

The drivers (or individual channels thereof) may be DMX (Digital Multiplexing) controlled, with each driver (or channel) programed with a different fixture ID. From this, separate activating, deactivating and diming permutations are possible for the streetlamp. Alternatively, the one or more drivers include a Digital Addressable Lighting Interface (DALI). From this configuration, as with the DMX controls, each luminaire is separately activated and dimmed. However, the overall creative concept disclosed herein is not limited the control protocol. Serial, proprietary Ethernet (such as Artnet) or other telecommunication protocols can be utilized.

The lamp configuration includes a ballast box 40 (FIG. 1) at a bottom thereof for uprightly supporting a lamp post 42. The post 42 supports the lamp head 12, through which power is supplied from the street side to the street lamp 10.

The head 12 can include an omni-directional lamp cover (FIG. 2). The cover 44 can be essentially clear glass, capable of distributing light substantially equally about the luminaire toward a street surface. That is, the cover 44 can be a non-refracting transparent cover.

The LED electronics in the head 12 include plural LED receptacles 46-52 (FIG. 4) for receiving the plural LED boards 14-20. Each of the receptacles can include optics for throwing light in a predetermined direction, or for providing other predetermined luminaire refractive effects, such as combining thrown light.

Furthermore, where head 12 can include a heat sink 54 (illustrated schematically in FIG. 3). The heat sink 54 serves as a mounding surface for the LED boards so that it can be cubic in shape.

Turning back to the lamp cover 44, the cover can be refracting, such as IES (Illuminating Engineering Society) types I-V. Such would be the case in configuration in which the controlled lighting system is retrofitted into a typical street lamp.

In the disclosed embodiment, when utilizing a clear glass cover, with all LEDs turned on, the lighting pattern would mimic an IES type V lighting condition, with light uniformly thrown from the lamp. However, with various luminaires turned off, the eight horizontal octants circumferentially disposed about the lamp would be lit according to more desired patterns. If a refractor cover were utilized, the patterns would be impacted further. In addition, refracting optics in the LED receptacles would impact light distribution further.

As indicated above, the ability to selectively light one circumferential region, that is, specific octant regions about the lamp, while leaving the others dim or turned off, is not possible with typical heads having single slight sources and conventional refractors. The disclosed embodiments, as can be appreciated, provide greater lighting flexibility to the benefit of store owners and those who may be interested in having a more natural or controlled lighting configuration at their property front.

The above disclosed embodiments are not mean to limit the breadth and scope of the claims, which are appended hereto. In addition, obvious modifications to the claims are deemed inherently expressed herein and covered by the claims.

We claim:

1) A street lamp comprising:
a head at a top thereof, which includes a plurality of luminaires, which are circumferentially offset relative to a top view thereof, whereby the plurality of luminaires face a corresponding plurality of directions;
one or more controllers for individually controlling the luminosity of the plurality of luminaires, whereby various, controllable light patterns are provided about a circumference of the lamp, with or without utilizing a refracting lamp cover.

2) The luminaire of claim 1, wherein the plurality of luminaires include at least two luminaires spaced in radially opposing directions relative to a top view of the street lamp.

3) The luminaire of claim 2, wherein the plurality of luminaires includes at least four luminaires spaced circumferentially equally relative to a top view of the street lamp.

4) The luminaire of claim 3, where the plural luminaires are plural LED boards.

5) The luminaire of claim 4, further comprising one or more LED drivers for controlling the plural LED boards.

6) The luminaire of claim 5, wherein the one or more drivers include plural LED drivers, one for each respective LED board.

7) The luminaire of claim 5, wherein the one or more drivers is one or more multichannel drivers, wherein each channel is separately controllable by the controller for individually powering each LED board.

8) The luminaire of claim 5, wherein the one or more drivers are remotely controlled via one or more telecommunication protocols, whereby each luminaire is separately activated and dimmed.

9) The luminaire of claim 1, further including a ballast box at a bottom thereof for uprightly supporting a lamp post, which supports the lamp head, and through which power is supplied to the street lamp.

10) The luminaire of claim 1, further comprising an omni-directional lamp cover, capable of distributing light substantially equally about the luminaire toward a street surface.

11) The luminaire of claim 10, wherein the lamp cover is a non-refracting transparent cover.

12) The luminaire of claim 1, comprising a refracting lamp cover.

13) The luminaire of claim 4, wherein the head includes plural LED receptacles for receiving the plural LED boards, each of which including optics for throwing light in a predetermined direction.

14) The luminaire of claim 4, wherein the head includes a heat sink on which each of the luminaires is mounted.
